(19) United States
(12) Patent Application Publication
(10) Pub. No.: US 2021/0016493 A1
(43) Pub. Date: Jan. 21, 2021

(54) HEAT TREATMENT OF 3D PRINTED PARTS FOR IMPROVING TRANSPARENCY, SMOOTHNESS AND ADHESION OF LAYERS

(71) Applicant: D. Swarovski KG, Wattens (AT)

(72) Inventors: Arik Bracha, Tel-Aviv (IL); Eran Gal-or, Kfar-Saba (IL)

(21) Appl. No.: 16/766,809

(22) PCT Filed: Nov. 21, 2018
(86) PCT No.: PCT/IB2018/059177

§ 371 Date: May 26, 2020

Related U.S. Application Data
(60) Provisional application No. 62/590,586, filed on Nov. 26, 2017.

(51) Int. Cl. B29C 64/118; B29C 64/245; B29C 64/232; B29C 64/25; B29C 64/268; B29C 64/286; B29C 64/209; B29C 64/393; B29C 64/321

(52) U.S. Cl. CPC B29C 64/118; B29C 64/245; B29C 64/232; B29C 64/25; B33Y 10/00; B29C 64/286; B29C 64/209; B29C 64/393; B29C 64/321; B29C 64/268

(57) ABSTRACT

A system for improving transparency and/or smoothness and/or adhesion of layers of a 3D printed object, comprising: a base plate; a 3D printed object mounted on the base plate; a controller; a motion system connected with the base plate and controlled by the controller for enabling movement in Z axis and at least one more axis; and at least one treating device; the at least one treating device configured to be directed towards the 3D printed object for heating a target spot area on one of the outer surface and the inner surface of the 3D printed object during the movement of the base plate.

### FIELD OF THE INVENTION

The present invention generally relates to printing systems and specifically to heat treatment of 3D printed parts for improving transparency, smoothness and adhesion of layers.

### CROSS-REFERENCE TO RELATED PATENT APPLICATIONS

This patent application claims priority from and is related to U.S. Provisional Patent Application Ser. No. 62/590,586, filed Nov. 26, 2017, this U.S. Provisional Patent Application incorporated by reference in its entirety herein.

### BACKGROUND

3D printing or Additive Manufacturing (AM), Fuse Depositing Modeling (FDM) and Fused Filament Fabrication (FFT) refer to any of the various processes for printing a three-dimensional object. Primarily additive processes are used, in which successive layers of material are laid down under computer control. These objects can be of almost any shape or geometry, and are produced from a 3D model or other electronic data source. Different types of 3D printers were developed over the years, such as 3D FDM (Fused Deposition Modeling) printers. 3D FDM printers are mostly based on melting a filament, e.g. plastics, in a printer head.

Various problems arise while printing low and high temperature melting materials. During the 3D printing process, the 3D object is made by depositing layers, one on top of the other and the final object's surface finish is not smooth. Moreover, while printing high temperature melting materials e.g. glass objects, the refraction of the light through the relatively rough surface makes the object look opaque, or at least not transparent enough.

There is a long felt need for a system enabling to solve these problems while printing a 3D object with low and high melting temperature printing materials.

### SUMMARY

According to an aspect of the present invention there is provided a system for improving transparency and/or smoothness and/or adhesion of layers of a 3D printed object, comprising: a base plate; a 3D printed object mounted on the base plate; a controller; a motion system connected with the base plate and controlled by the controller for enabling movement in Z axis and at least one more axis; and at least one treating device; the at least one treating device configured to be directed towards the 3D printed object for heating a target spot area on one of the outer surface and the inner surface of the 3D printed object during the movement of the base plate.

The 3D printed object may be made of one of glass, plastic and metal.

The system may further comprise a heated chamber having a first opening, and at least one second opening and/or at least one window; wherein the base plate and the 3D printed object are mounted inside the heated chamber; and the motion system, the controller and the treating device are mounted outside the heated chamber.

The system may further comprise a thermal insulation blanket configured to cover the first opening for insulating the heated chamber from the surrounding.

The controller may be configured to receive a representation of the 3D printed object and control the treating device and the movement of the base plate accordingly.

The controller may further be configured to move the base plate according to at least one of the 3D printed object's shape, the 3D printed object's contour and the thickness of the 3D printed object's walls.

The controller may further be configured to control the heating power of the treating device according to at least one of the 3D printed object's wall thickness and the 3D printed object's printing material.

The controller may further be configured to control the target spot area's size, exposure time and special heating patterns depending on the 3D printed object, the 3D printed object's wall thickness and the 3D printed object's printing material.

The treating device may be one of a laser source, a flame heat source and an arc heat source.

The laser beam of the laser source may be directed towards the 3D printed object via a mirror.

The treating device may be an arc heat source; the system may further comprise an air or gas source and a pipe connected on one end thereof to the air or gas source and configured to blow air or gas from its other end in order to direct the arc heat source's heat towards the 3D printed object.

The heated chamber may further comprise a third opening on its upper side; the system may further comprise: a printing nozzle mounted partially inside the heated chamber; a nozzle heating unit mounted inside the heated chamber; and a nozzle cooling unit mounted outside the heated chamber and surrounding the upper side of the printing nozzle for cooling the upper side of the printing nozzle.

The nozzle heating unit may be an induction coil mounted around the lower side of the printing nozzle at a distance from the outer surface of the printing nozzle for heating the printing nozzle; the system may further comprise an induction machine for activating the induction coil.

According to another aspect of the present invention there is provided a method of improving transparency and/or smoothness and/or adhesion of layers of a 3D printed object, comprising: a. receiving, by a controller, a representation of a 3D object to be printed; b. printing, by a printing head, a layer of the 3D object on a base plate; c. activating, by the controller, a treating device and controlling the motion of the base plate for treating the printed layer; and d. repeating steps b and c until the 3D object is fully printed.

The method may further comprise: adjusting at least one of a heating intensity of the treating device; and a target spot area's size on one of the outer surface and the inner surface of the 3D printed object.

The 3D printed object may be made of one of glass, plastic and metal.

According to another aspect of the present invention there is provided a method of improving transparency and/or smoothness and/or adhesion of layers of a 3D printed object, comprising: a. receiving, by a controller, a representation of a 3D object to be printed; b. printing, by a printing head, the 3D object on a base plate; and c. activating, by the controller, a treating device and controlling the motion of the base plate for treating the 3D object.

The method may further comprise: adjusting at least one of a heating intensity of the treating device; and a target spot area's size on one of the outer surface and the inner surface of the 3D printed object.

The 3D printed object may be made of one of glass, plastic and metal.

According to another aspect of the present invention there is provided a method of improving transparency and/or smoothness and/or adhesion of layers of a 3D printed object, comprising: a. receiving, by a controller, a representation of a 3D object to be printed; b. printing, by a printing head, a layer of the 3D object on a base plate; and simultaneously activating, by the controller, a treating device for treating the printed layer; c. repeating step b until the 3D object is fully printed.

The method may further comprise: adjusting at least one of a heating intensity of the treating device; and a target spot area's size on one of the outer surface and the inner surface of the 3D printed object.

The 3D printed object may be made of one of glass, plastic and metal.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a cross section view of an exemplary system for improving transparency and/or smoothness and/or adhesion of layers of a 3D printed object (TSA) according to embodiments of the present invention;

FIG. 1A is a cross section view of the TSA system of FIG. 1 while treating the inner surface of the 3D printed object;

FIG. 2 is a cross section view of another exemplary TSA system according to embodiments of the present invention;

FIG. 3 is a cross section view of another exemplary TSA system according to embodiments of the present invention;

FIG. 4 is a cross section view of another exemplary TSA system according to embodiments of the present invention;

FIG. 5 is a flowchart showing an exemplary process which may be performed by either one of the TSA systems;

FIG. 6 is a flowchart showing another exemplary process which may be performed by either one of the TSA systems;

FIG. 7 is a flowchart showing another exemplary process which may be performed by either one of the TSA systems; and

FIG. 8 is a cross section view of an exemplary system for improving transparency and/or smoothness and/or adhesion of layers of a 3D printed object after printing according to embodiments of the present invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a system for improving transparency and/or smoothness and/or adhesion of layers of a 3D printed object.

The capabilities of the system according to embodiments of the present invention may be applied to glass 3D printed object in order to improve the transparency of the object and/or the smoothness of the object's surface and/or the adhesion of the object's layers but also may be applied to plastic and metal 3D printed objects in order to smoothen the object's surface finish and/or the adhesion of the object's layers.

Using a controllable heat source (a treating device) e.g., a laser, a flame, an arc heating, etc. it is possible to melt a relatively small surface area and achieve the goal.

The melted material flows and smoothens the surface finish. Smoothing the glass 3D printed object's surface improves its transparency.

It will be appreciated that the described process may be implemented during the printing process or after printing in a separate process or even in a different device.

During a 3D printing process, a 3D object is made by depositing layers, one on top of the other which leads to a final object's surface finish which is not smooth. While printing high temperature melting materials, e.g., glass objects, the refraction of the light through the relatively rough surface makes the object look opaque, or at least not transparent enough.

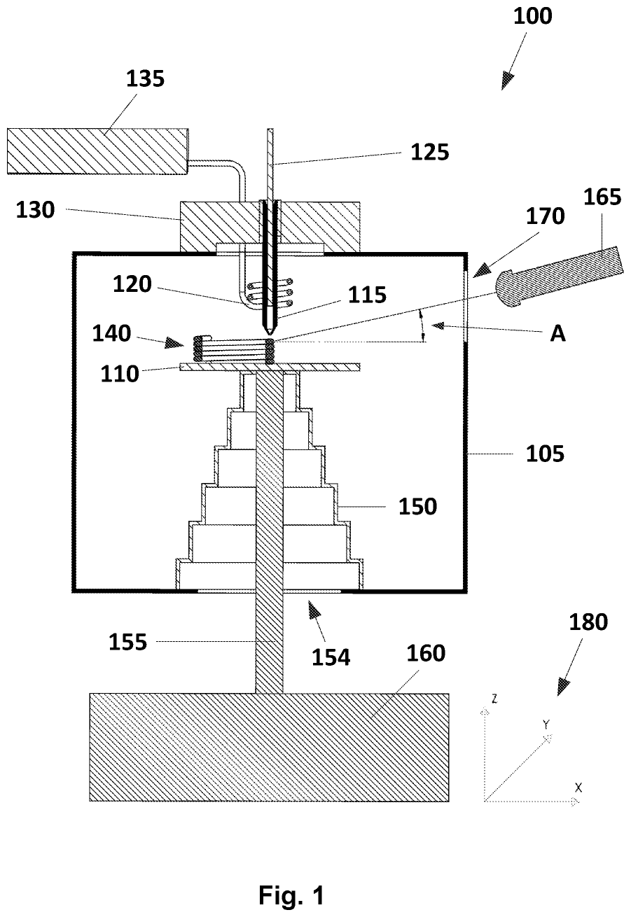

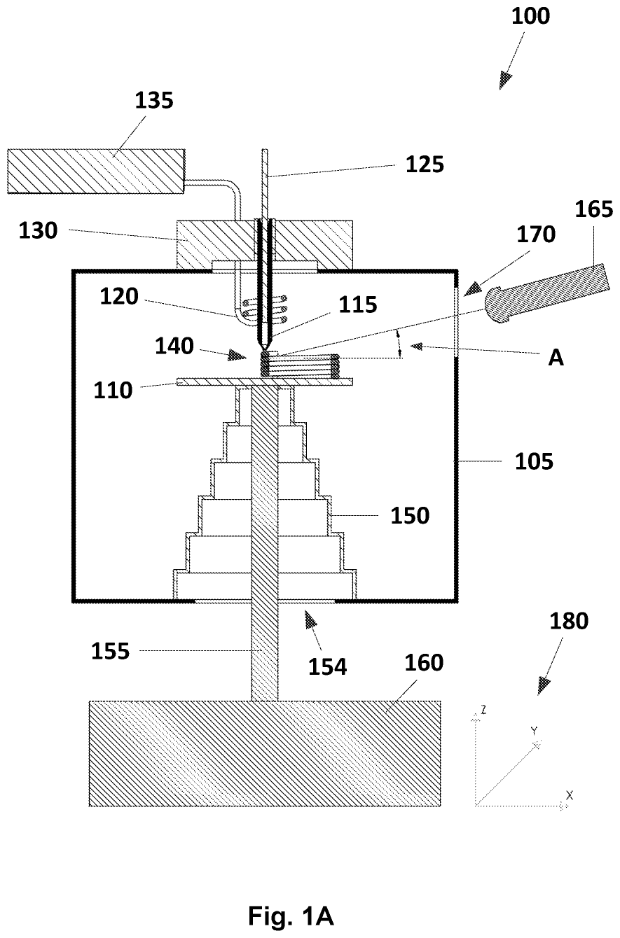

FIG. 1 is a cross section view of an exemplary system 100 for improving transparency and/or smoothness and/or adhesion of layers of a 3D printed object according to embodiments of the present invention. For the purpose of simplicity the system may be called hereandbelow a TSA system. The TSA system 100 comprises: a heated chamber/furnace 105; a printing base plate/substrate 110 mounted inside the heated chamber 105 for the 3D printed object 140 to be printed on; a printing nozzle 115 mounted partially inside the heated chamber 105; a nozzle heating unit (e.g., an induction coil) 120 mounted inside the heated chamber 105 and around the lower side of the nozzle 115 at a distance from the outer surface of the nozzle 115 for heating the nozzle; printing material 125 (e.g., rod, spool, etc.); a nozzle cooling unit 130 mounted outside the heated chamber 105 and surrounding the upper side of the nozzle 115 for cooling the upper side of the nozzle; an induction machine 135 for activating the induction coil 120; a printer controller (not shown) for controlling the TSA system 100 and a printer motion system 160 connected via rod 155 to the printing base plate/substrate 110 and controlled by the printer controller which enables XYZ (180) movements and a rotational movement of the printing base plate/substrate 110 around Z axis. According to embodiments of the present invention, an opening 154 at the bottom of the heated chamber that enables the movement of the printing base plate/substrate 110 is covered by a thermal insulation blanket 150 in order to insulate the heated chamber 105 from the surrounding. According to embodiments of the present invention, the TSA system 100 further comprises at least one treating device (e.g., a laser source 165) mounted outside the heated chamber 105 and directed towards the 3D printed object 140, slightly below the nozzle 115 tip. The laser beam of the laser source 165 passes through at least one window or opening 170 in the heated chamber's 105 wall and hits the 3D printed object 140 at an angle “A” thus heating a target spot area on the outer surface of the 3D printed object 140 and smoothing the object's outer surface. According to embodiments of the present invention, the printer controller receives a representation of the 3D object to be printed and controls the printing nozzle 115, the motion of the printing base plate/substrate 110, the nozzle cooling unit 130 and the treating device. The printer controller is programmed to move the printing base plate/substrate 110 according to the printed object 140 shape, contour, thickness of the object's walls, etc., control the heating power according to the printed object's wall thickness, printing material, etc., the target spot area's size, exposure time and special heating patterns depending on the printed object. According to embodiments of the present invention, in order to control the target spot area's size the system 100 may further comprise optics, e.g., at least one lens.

If the printing material is a rod or a spool it is intended to be pushed by a feeding mechanism (not shown) from the upper cold side of the nozzle 115 towards the lower hot side of the nozzle 115 and heated and melted while passing through the nozzle that is heated by the heating unit 120. It will be appreciated that the system of the present invention is not limited to a specific feeding mechanism or to printing material which is a rod or a spool.

It will be appreciated that the TSA system 100 is not limited to include all the above parts. The mandatory parts which must be included in the TSA system 100 are a printing base plate/substrate; a printing head; printing material; a printer controller for controlling the TSA system 100; a printer motion system controlled by the printer controller and enabling movement in Z axis and at least one more axis (e.g., X, Y or a rotational movement of the base plate/substrate around Z axis); and at least one treating device (e.g., a laser source).

If the process is performed after printing in a separate device, the mandatory parts which must be included in this device are a base plate/substrate; a motion system controlled by a controller and enabling movement in Z axis and at least one more axis (e.g., X, Y or a rotational movement of the base plate/substrate around Z axis); and at least one treating device (e.g., a laser source).

According to embodiments of the present invention, for the purpose of e.g., adhesion of layers, the treating device may be directed towards a different location, i.e., the upper side of the previous printed layer.

According to embodiments of the present invention, the laser source 165 may also be used to create holes in the printed object, patterns on the object's wall, etc.

It will be appreciated that the nozzle heating unit 120 is not limited to an induction coil, e.g., resistance heating coils may be used.

It will be appreciated that the present invention is not limited to a single treating device and a single window or opening and any number of treating devices and windows or openings may be used. It will be appreciated that the at least one treating device may be fixed or movable by the printer controller.

FIG. 1A is a cross section view of the TSA system 100 while treating the inner surface of the 3D printed object 140.

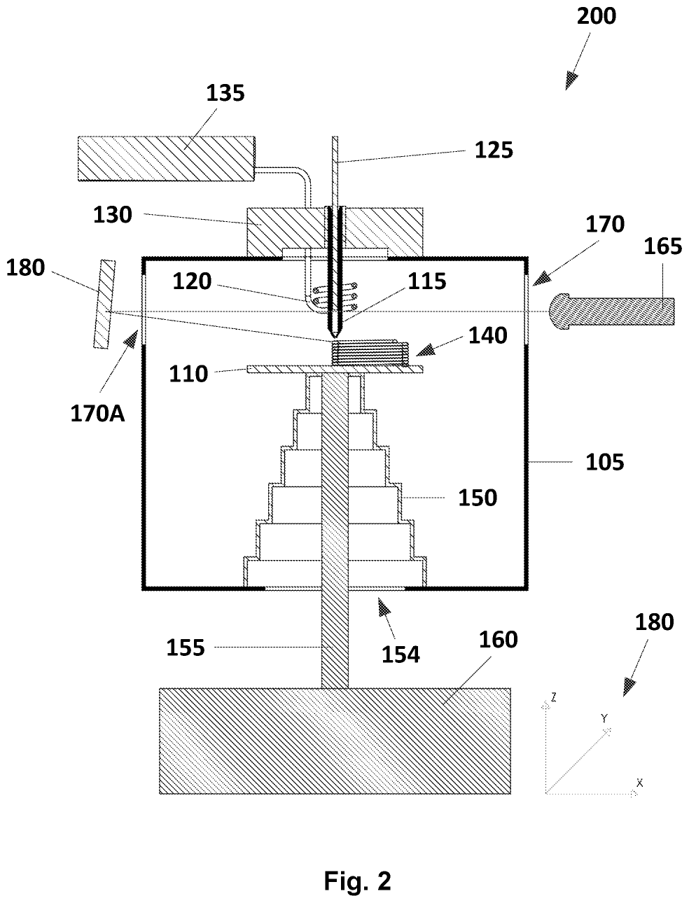

FIG. 2 is a cross section view of another exemplary TSA system 200 according to embodiments of the present invention. The TSA system 200 comprises all the parts described in conjunction with FIG. 1 and further comprises another window or opening 170A in the heated chamber's 105 wall and a mirror 180 mounted at a fixed angle relative to the heated chamber's 105 wall. According to embodiments of the present invention the mirror 180 may be a moving mirror controlled by the printer controller. The laser source's beam passes through the window or opening 170, the window or opening 170A and is reflected back from the mirror 180 towards the 3D printed object 140 thus heating the target spot area on the outer surface of the 3D printed object 140 and smoothing the object's outer surface.

It will be appreciated that the same process may be done for treating the inner surface of the 3D printed object 140.

According to embodiments of the present invention, the mirror 180 may be mounted inside the heated chamber 105. In such a case, the window or opening 170A is unnecessary. The laser source's laser beam passes through the window or opening 170 and is reflected back from the mirror 180 towards the 3D printed object 140 thus heating the target spot area on the outer surface of the 3D printed object 140 and smoothing the object's outer surface. It will be appreciated that the same process may be done for treating the inner surface of the 3D printed object 140.

Again, it will be appreciated that the TSA system 200 is not limited to include all the above parts. The mandatory parts which must be included in the TSA system 200 are a printing base plate/substrate; a printing head; printing material; a mirror; a printer controller for controlling the TSA system; a printer motion system controlled by the printer controller and enabling movement in Z axis and at least one more axis (e.g., X, Y or a rotational movement of the base plate/substrate around Z axis); and at least one treating device (e.g., a laser source).

If the process is performed after printing in a separate device, the mandatory parts which must be included in this device are a base plate/substrate; a mirror; a motion system controlled by a controller and enabling movement in Z axis and at least one more axis (e.g., X, Y or a rotational movement of the base plate/substrate around Z axis); and at least one laser source.

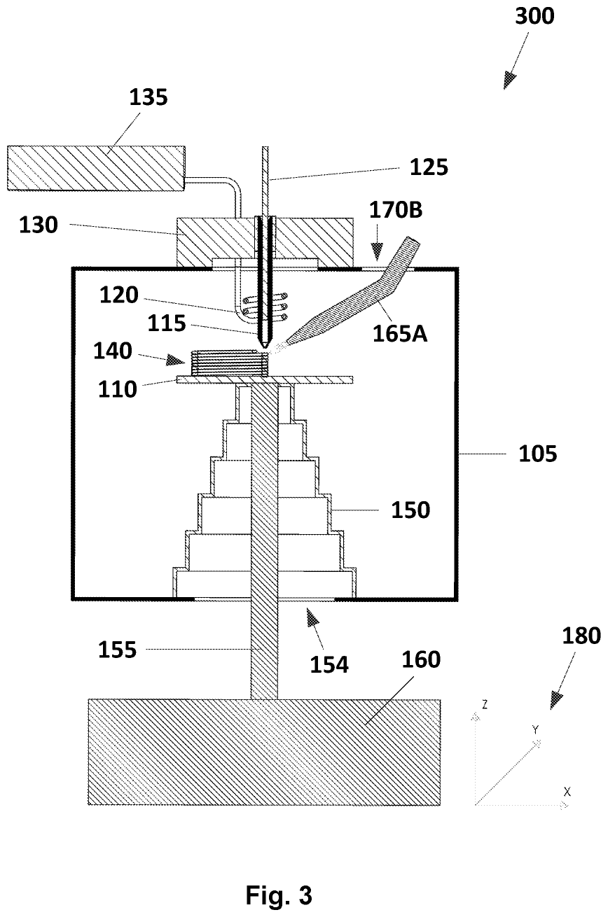

FIG. 3 is a cross section view of another exemplary TSA system 300 according to embodiments of the present invention. The TSA system 300 comprises all the parts described in conjunction with FIG. 1 except the laser source 165 and the location of the opening in the heated chamber's wall. Instead of the laser source 165, the TSA system 300 comprises a different treating device—a flame heat source 165A, such as Alpha Glass Working Torch available from Bethlehem Burners™, mounted through the opening 170B and directed towards the printed object 140.

It will be appreciated that the present invention is not limited to a single flame heat source and a single opening and any number of flame heat sources and openings may be used. It will be appreciated that the at least one flame heat source may be fixed or movable by the printer controller.

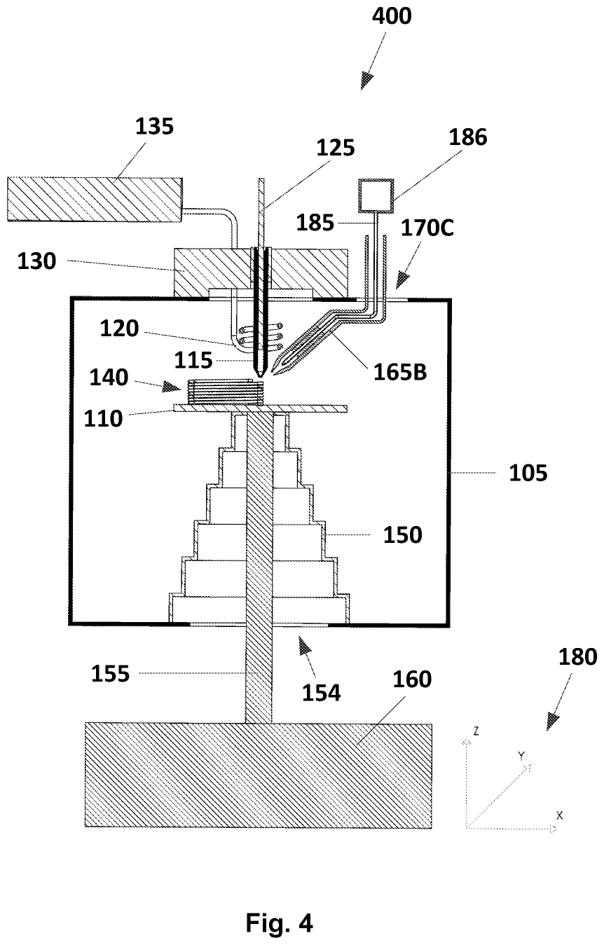

FIG. 4 is a cross section view of another exemplary TSA system 400. The TSA system 400 comprises all the parts described in conjunction with FIG. 1 except the laser source 165 and the location of the opening in the heated chamber's wall. Instead of the laser source 165, the TSA system 400 comprises a different treating device—an arc heat source 165B, such as Arc lighter available from Tesla Coil Lighters^{T} mounted through the opening 170C and directed towards the printed object 140. According to embodiments of the present invention, the system 400 may further comprise a pipe 185 connected on one end thereof to an air/gas source 186 and configured to blow air/gas from its other end in order to direct the arc heat source's heat towards the printed object 140. According to embodiments of the present invention, the printer controller may be further configured to adjust the blowing strength according to the needs, e.g., the printing material.

It will be appreciated that the present invention is not limited to a single arc heat source and a single opening and any number of arc heat sources and openings may be used. It will be appreciated that the at least one arc heat source may be fixed or movable by the printer controller.

Again, it will be appreciated that the TSA system 300 and the TSA system 400 are not limited to include all the above parts. The mandatory parts which must be included in the TSA systems 300 or 400 are a printing base plate/substrate; a printing head; printing material; a printer controller for controlling the TSA system; a printer motion system controlled by the printer controller and enabling movement in Z axis and at least one more axis (e.g., X, Y or a rotational movement of the base plate/substrate around Z axis); and at least one treating device (e.g., a flame heat source, an arc heat source, etc.).

If the process is performed after printing in a separate device, the mandatory parts which must be included in this device are a base plate/substrate; a motion system controlled by a controller and enabling movement in Z axis and at least one more axis (e.g., X, Y or a rotational movement of the base plate/substrate around Z axis); and at least one treating device (e.g., a flame heat source, an arc heat source, etc.).

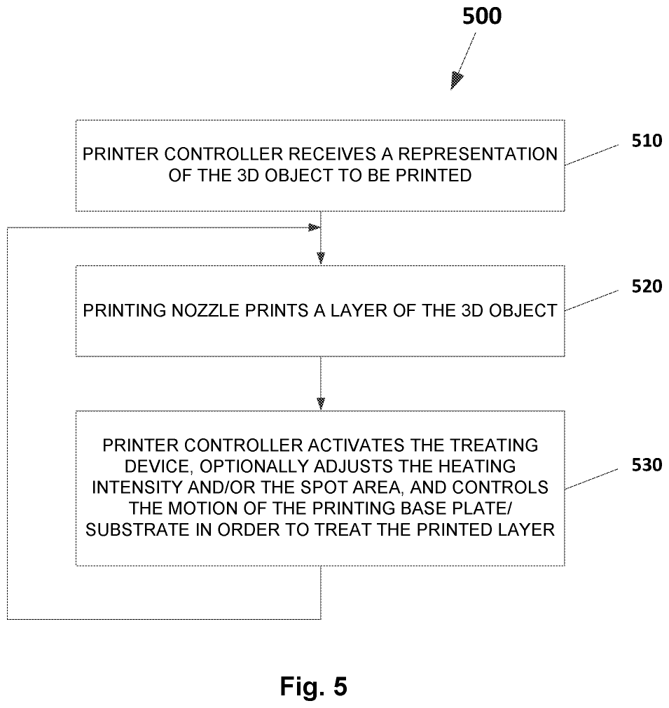

FIG. 5 is a flowchart 500 showing an exemplary process which may be performed by either one of the above described TSA systems (100-400). In step 510, the printer controller receives a representation of the 3D object to be printed. In step 520, the printing nozzle prints a layer of the 3D object. In step 530, the printer controller activates the treating device, optionally adjusts the heating intensity and/or the spot area, and controls the motion of the printing base plate/substrate in order to treat the printed layer. The process returns to step 520 up to a point where the 3D object is fully printed.

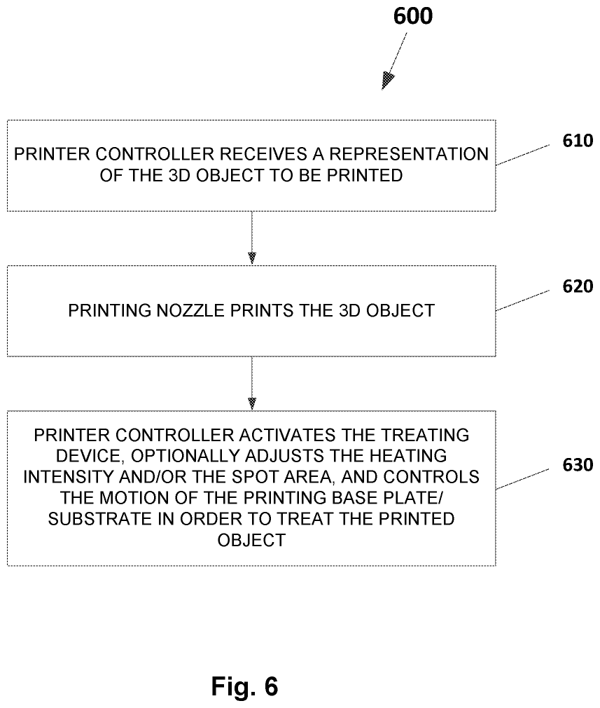

FIG. 6 is a flowchart 600 showing another exemplary process which may be performed by either one of the above described TSA systems (100-400). In step 610, the printer controller receives a representation of the 3D object to be printed. In step 620, the printing nozzle prints the 3D object. In step 630, the printing controller activates the treating device, optionally adjusts the heating intensity and/or the spot area, and controls the motion of the printing base plate/substrate in order to treat the printed object.

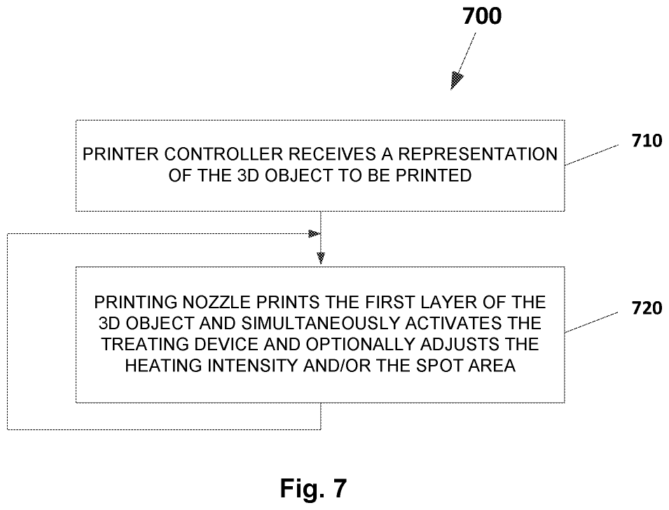

FIG. 7 is a flowchart 700 showing another exemplary process which may be performed by either one of the above described TSA systems (100-400). In step 710, the printer controller receives a representation of the 3D object to be printed. In step 720, the printing nozzle prints the first layer of the 3D object and simultaneously activates the treating device and optionally adjusts the heating intensity and/or the spot area. The process loops, up to a point where the 3D object is fully printed.

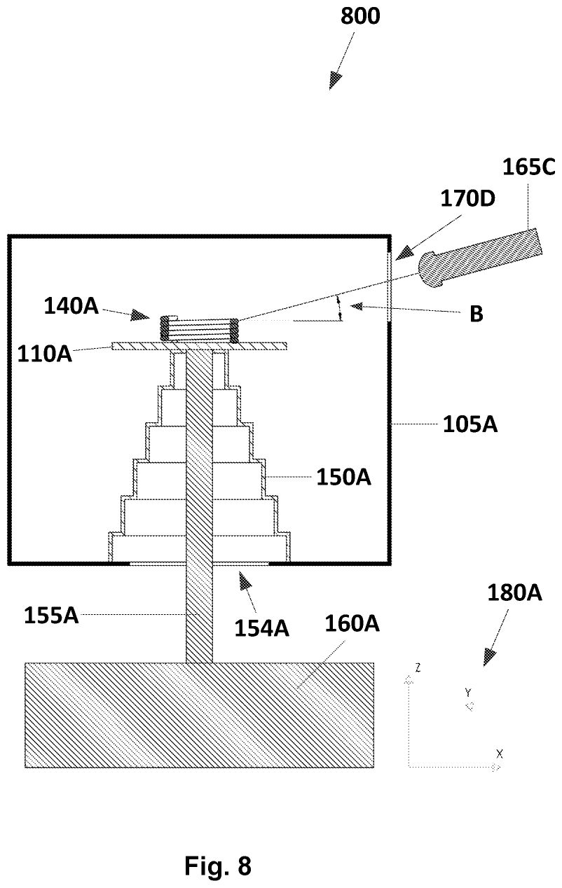

FIG. 8 is a cross section view of an exemplary system 800 for improving transparency and/or smoothness and/or adhesion of layers of a 3D printed object after printing according to embodiments of the present invention. The system 800 comprises: a heated chamber/furnace 105A; a base plate/substrate 110A mounted inside the heated chamber 105A for the 3D printed object 140A to be mounted on; a controller (not shown) for controlling the system 800 and a motion system 160A connected via rod 155A to the base plate/substrate 110A and controlled by the controller which enables XYZ (180A) movements and a rotational movement of the base plate/substrate 110A around Z axis. According to embodiments of the present invention, an opening 154A at the bottom of the heated chamber that enables the movement of the base plate/substrate 110A is covered by a thermal insulation blanket 150A in order to insulate the heated chamber 105A from the surrounding. According to embodiments of the present invention, the system 800 further comprises at least one treating device (e.g., a laser source 165C) mounted outside the heated chamber 105A and directed towards the 3D printed object 140A. The laser beam of the laser source 165C passes through at least one window or opening 170D in the heated chambers 105A wall and hits the 3D printed object 140A at an angle “B” thus heating a target spot area on the outer surface of the 3D printed object 140A and smoothing the object's outer surface. According to embodiments of the present invention, the controller receives a representation of the 3D object and controls the motion of the base plate/substrate 110A. The controller is programmed to move the base plate/substrate 110A according to the printed object 140A shape, contour, thickness of the object's walls, etc., control the heating power according to the printed object's wall thickness, printing material, etc., the target spot area's size, exposure time and special heating patterns depending on the printed object. According to embodiments of the present invention, in order to control the target spot area's size the system 800 may further comprise optics, e.g., at least one lens.

Again, it will be appreciated that the mandatory parts which must be included in the system 800 are a base plate/substrate; a motion system controlled by a controller and enabling movement in Z axis and at least one more axis (e.g., X, Y or a rotational movement of the base plate/substrate around Z axis); and at least one treating device (e.g., a laser source, flame heat source, etc.).

It will be appreciated that the motion systems (160/160A) of the above embodiments are not limited to be located underneath the heated chamber. According to embodiments of the present invention, the motion system (160,160A) may be located, e.g., alongside the heated chamber.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A system for improving transparency and/or smoothness and/or adhesion of layers of a 3D printed object, the system comprising:
a base plate;
a 3D printed object mounted on said base plate;
a controller;
a motion system connected with said base plate and controlled by said controller for enabling movement in a Z axis and at least one more axis; and
at least one treating device;
said at least one treating device configured to be directed towards said 3D printed object for heating a target spot area on one of an outer surface and an inner surface of said 3D printed object during said movement of said base plate.

2. The system of claim 1, wherein said 3D printed object is made of one of glass, plastic and metal.

3. The system of claim 1, further comprising a heated chamber having a first opening, and at least one second opening and/or at least one window; wherein said base plate and said 3D printed object are mounted inside said heated chamber; and said motion system, said controller and said treating device are mounted outside said heated chamber.

4. (canceled)

5. The system of claim 1, wherein said controller is configured to receive a representation of said 3D printed object and control said treating device and said movement of said base plate accordingly.

6. The system of claim 5, wherein said controller is further configured to move said base plate according to at least one of a shape of said 3D printed object, a contour of said 3D printed object or a wall thickness of said 3D printed object.

7. The system of claim 5, wherein said controller is further configured to control a heating power of said treating device according to at least one of a wall thickness of said 3D printed object or a printing material of said 3D printed object.

8. The system of claim 5, wherein said controller is further configured to control a size of said target spot area, exposure time and special heating patterns depending on said 3D printed object, a wall thickness of said 3D printed object and a printing material of said 3D printed object.

9. The system of claim 1, wherein said treating device is one of a laser source, a flame heat source and an arc heat source.

10. The system of claim 1, wherein said treating device is a laser source and a laser beam of said laser source is directed towards said 3D printed object via a mirror.

11. (canceled)

12. The system of claim 3, wherein said heated chamber further comprises a third opening on an upper side of said heated chamber; and wherein said system further comprises:
a printing nozzle mounted partially inside said heated chamber;
a nozzle heating unit mounted inside said heated chamber; and
a nozzle cooling unit mounted outside said heated chamber and surrounding an upper side of said printing nozzle for cooling the upper side of said printing nozzle.

13. The system of claim 12, wherein said nozzle heating unit is an induction coil mounted around a lower side of said printing nozzle at a distance from an outer surface of said printing nozzle for heating said printing nozzle; and wherein said system further comprises an induction machine for activating said induction coil.

14. A method of improving transparency and/or smoothness and/or adhesion of layers of a 3D printed object, comprising:
(a) receiving, by a controller, a representation of a 3D object to be printed;
(b) printing, by a printing head, a layer of said 3D object on a base plate;
(c) activating, by said controller, a treating device for treating said printed layer; and
(d) repeating steps (b) and (c) until said 3D object is fully printed.

15. The method of claim 14, further comprising:
adjusting at least one of a heating intensity of said treating device or a size of a target spot area on one of an outer surface and an inner surface of said 3D printed object.

16. The method of claim 14, wherein said 3D printed object is made of one of glass, plastic and metal.

17. A method of improving transparency and/or smoothness and/or adhesion of layers of a 3D printed object, comprising:
(a) receiving, by a controller, a representation of a 3D object to be printed;
(b) printing, by a printing head, said 3D object on a base plate; and
(c) activating, by said controller, a treating device and controlling a motion of said base plate for treating said 3D object.

18.-22. (canceled)

23. The system of claim 10, further comprising at least one lens to control a size of the target spot area of the laser beam of the laser source.

24. The system of claim 12, wherein a printing material is in the form of a rod or a spool, and the system further comprises a feeding mechanism for pushing the rod or spool from the upper side of the printing nozzle towards the lower side of the printing nozzle, wherein the upper side of the printing nozzle is cold and the lower side of the printing nozzle is hot.

25. The method of claim 14, wherein step (c) further comprises the controller activating said treating device and controlling a motion of the base plate for treating said printed layer.

26. The method of claim 14, wherein step (c) is performed simultaneously with step (b).

27. The method of claim 14, wherein said treating device is a laser source and a laser beam of said laser source is directed towards said 3D printed object via a mirror and/or at least one lens.
